(19) United States
(12) Patent Application Publication
(10) Pub. No.: US 2009/0114036 A1
(43) Pub. Date: May 7, 2009

(54) Use of Reed Switch and Magnet to Detect Movement of Faucet Handle

(75) Inventors: Anitha Dhulipudi, Olathe, KS (US); Keith R. DeBald, Gardner, KS (US); Joseph C. Dettmer, Overland Park, KS (US); James M. Nordstrom, Olathe, KS (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: BE INTELLECTUAL PROPERTY, INC., Lenexa, KS (US)

(21) Appl. No.: 12/260,750

(22) Filed: Oct. 29, 2008

Related U.S. Application Data
(60) Provisional application No. 60/983,369, filed on Oct. 29, 2007.

(51) Int. Cl. G01F 1/58

(52) U.S. Cl. 73/861.11

(57) ABSTRACT

A flow sensing apparatus detects movement of a faucet handle of a faucet of a hot water container in order to detect flow from the hot water container. A reed switch and an associated magnet can be mounted to detect open and closed positions of the faucet handle to provide electronic logic information regarding the status of the faucet handle position as an indication of a flow condition to a control unit that controls heating of water in the hot water container.

### CROSS-REFERENCES TO RELATED APPLICATIONS

This application is based upon U.S. Provisional Application No. 60/983,369, filed 29 Oct. 2007.

### BACKGROUND OF THE INVENTION

1. Field of the Invention

The present invention relates generally to the field of beverage makers, coffee makers, water heaters, and water boilers, and more particularly relates to a system for detecting flow in hot water containers such as in galley inserts on aircraft.

2. General Background and State-of-the-Art

Referring to FIG. 1, illustrating a prior art water boiler having a manual faucet or tap 10, operated manually by a handle 12 to dispense hot water from a water tank 14, certain water boilers, water heaters, coffee makers or the like, hereafter referred to as “units,” use such a manual faucet or tap to dispense hot water. In these units, the control circuitry that controls heating of the water does not initiate heating of the water as soon as water is being dispensed. These units' control circuits solely rely on detection of the temperature of the water in the tank to turn the heaters on and off. In these units, the heaters are turned on only when the detected water temperature inside the tank falls below a pre-set limit. As a result, the control circuitry cannot anticipate the need for heating the water. The drawback of this approach is that it creates a delay between the time when water is being withdrawn and when the heaters are turned on.

It would be desirable to provide a more reliable, less expensive, and lighter system to detect flow from a water heater container, using a sensor to detect and convert physical movement of the faucet handle to an open or closed circuit. The present invention satisfies these and other needs.

### SUMMARY OF THE INVENTION

Briefly, and in general terms, the present invention provides a system to detect flow through a faucet of a water heater container by using a sensor to detect and convert physical movement of the faucet handle to provide a signal indicating an open or closed circuit. For example, based upon signals from the sensor, an electronic control system logic may anticipate the need for water reheating when the faucet is opened by the user.

The faucet handle includes a movable portion that is movable between an open position allowing flow through the faucet and a closed position preventing flow through the faucet. The sensor is cooperatively mounted in association with the movable portion of the faucet handle to detect movement of the movable portion of the faucet handle between the open position of the faucet handle and the closed position of the faucet handle; and, the sensor generates a faucet position signal indicating whether the movable portion of the faucet handle is in the open position or the closed position. As a result, the volume of hot water (above certain temperature) that can be drawn increases and the recovery time required to heat the water in the tank is reduced. Conversely, the electronic control system logic may stop reheating the water tank if the user is not operating the faucet.

In a presently preferred embodiment, the sensor is a proximity sensor, including a magnet mounted to one of the faucet handles and a fixed location adjacent to the faucet handle, and a reed switch mounted to the other of the faucet handles and the fixed location adjacent to the faucet handle. The magnet can be mounted to the movable portion of the faucet handle, such as a back surface of the faucet handle, or within the movable portion of the faucet handle, for example. The magnet may be a permanent magnet, or an electromagnet, for example. The reed switch typically can be a normally open, axial, single pole, single throw reed switch encapsulated in plastic housing, for example.

An electronic control unit may also be provided that is configured to receive the faucet position signal to optimize heating of water inside the water heater container responsive to the faucet position signal. For example, the electronic control unit may be configured with a control logic operative to switch on a heating element in the water heater container as soon as the switch faucet position signal is received indicating flow through the faucet.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a perspective view of a prior art water boiler.

FIG. 2A is a schematic diagram of a first embodiment of a flow sensing apparatus utilizing a reed switch according to the present invention, showing a no-flow condition with the faucet in a closed position and the reed switch circuit in a closed configuration.

FIG. 2B is a schematic diagram similar to FIG. 2A, showing a flow condition with the faucet in an open position and the reed switch circuit in an open configuration.

### DETAILED DESCRIPTION OF THE PREFERRED EMBODIMENTS

Referring to the drawings, the present invention provides for a system to detect flow from a water heater container, involving the use of a sensor mounted in association with a faucet handle of the water heater container in order to detect movement of the faucet handle of the water heater container. An electrical signal of the sensor (open or closed) is used to provide the electronic logic information regarding the status of the faucet handle position (open or closed). This information is processed by the galley inserts electronics to optimize the reheating of the water inside the heating tank.

Reed switches typically contain two electrically conductive, magnetizable, spaced apart metal reeds positioned and sealed in a non-magnetic container. Stiffness of the reeds biases opposing electrical contacts on the metal reeds to be spaced apart in an open configuration. However, proximity of the metal reeds to a magnetic field from an associated electromagnet or permanent magnet causes the metal reeds to move together to a closed configuration with the electrical contacts electrically connected. The reed switches and magnets are readily available through several manufacturers at specific desired sensitivity and magnetic strength (flux density) respectively to achieve specific distance needed between the switch and the magnet for our application at a very low cost. No adjustment will be needed during assembly, unlike implementing a mechanical switch.

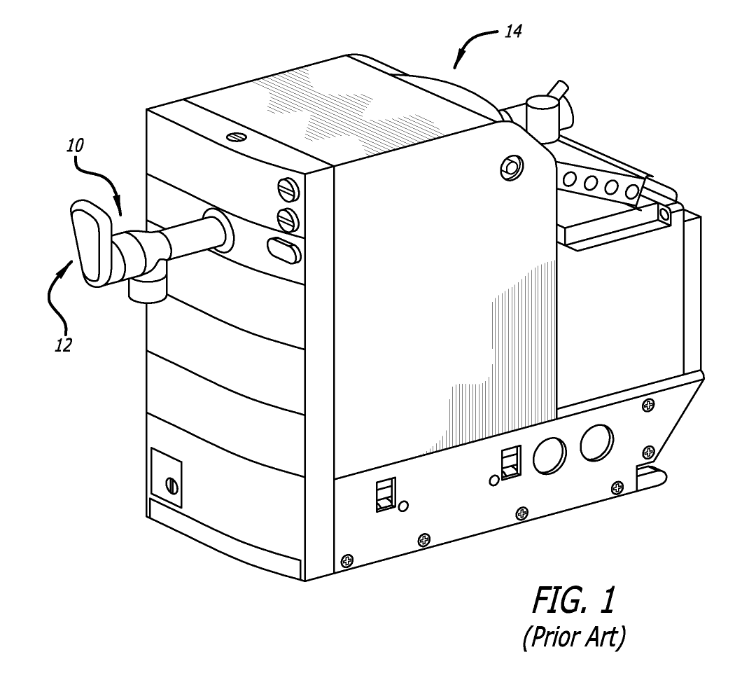

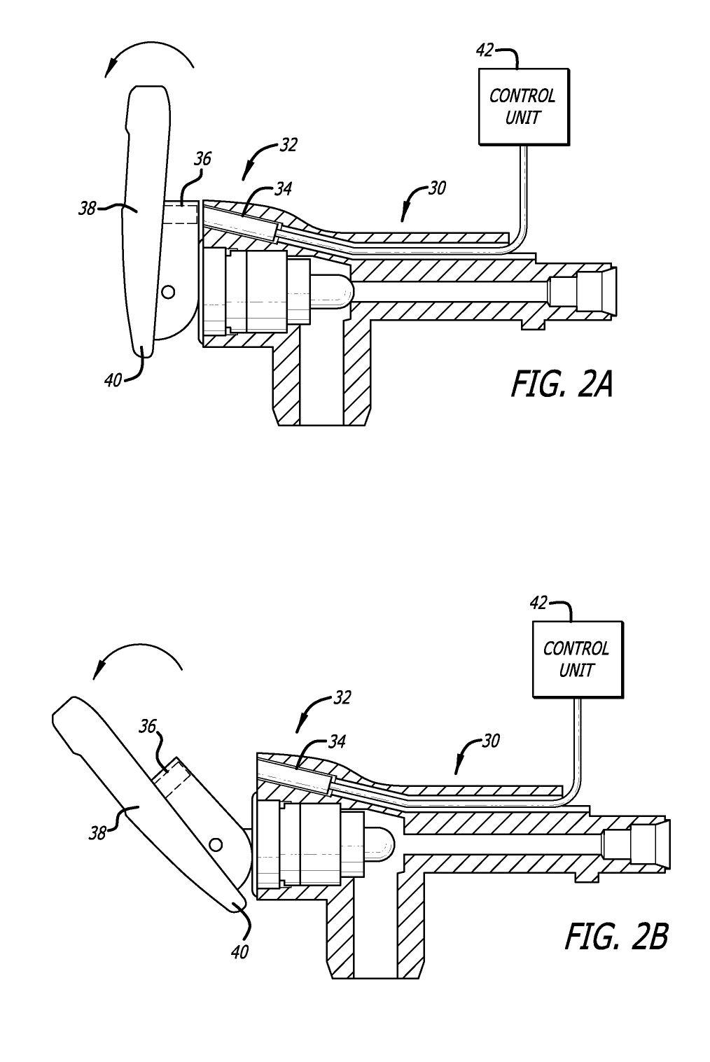

Referring to FIGS. 2A and 2B, in the first preferred embodiment of the invention, a water boiler (not shown) similar to that of FIG. 1 can be constructed with a front panel (not shown) having a water faucet 30 with a proximity sensor 32 utilizing a reed switch 34 to sense flow through the water faucet, and an associated magnet 36 mounted to a movable portion 38 of the faucet handle 40. The reed switch can be mounted within a portion of the water faucet, as is illustrated in FIGS. 3A and 3B, or can be mounted to an external surface of the water faucet, such as by being bonded to a top surface of the water faucet, just behind the faucet handle, for example, or any other suitable fixed location adjacent to the movable portion of the faucet handle. The magnet may be a permanent magnet mounted within the movable portion of the faucet handle, as is illustrated in FIGS. 3A and 3B, or can be bonded to a surface of the faucet handle, such as the back surface, using adhesive, for example. Alternatively, a suitable electromagnet may be used instead of a permanent magnet.

When the faucet handle is moved from the closed position, shown in FIG. 3A, to the open position, shown in FIG. 3B, to draw water from the water boiler tank, the magnet is moved away from the reed switch, activating the switch to signal withdrawal of water from the tank. Alternatively, the arrangement of the reed switch and associated magnet may also be reversed, so that the reed switch is mounted to the faucet handle and the magnet is mounted to the water faucet or other surface adjacent to the faucet handle. The reed switch can be connected to an electronic control unit 42, such as a PC board, for example, that can be configured with a control logic to switch on the heating elements in a water heater or water boiler as soon as the switch signal indicating withdrawal of water from the tank is detected, thus improving the recovery time.

A simple, normally open, axial, single pole, single throw reed switch encapsulated in plastic housing is suitable in the present invention. Since such a reed switch uses a sealed construction, it is insensitive to the environment in which it is installed and is not affected by steam or water intrusion or any other contaminants. This rigid construction guarantees long life. The reed switch is not required to carry any load, which means it possess very low contact resistance making it highly reliable.

The switch sensitivity and magnetic flux density of the magnet are selected according to the dimensions and requirements of the faucet and handle of the water heater container to which they are to be mounted, and no accurate alignment is necessary during assembly. The design intent is met even if the switch and magnet on the handle are slightly off-center. The biggest advantages of using a reed switch and a magnet are their miniature size and ease of installation. The faucet body is designed to capture the reed switch, and the faucet handle is designed to hold the magnet. No special mounting brackets are required for installation, and only a very small amount of adhesive is needed to install them in place. Because of their size, the reed switch and associated magnet are non-obtrusive and are literally hidden when installed, and do not adversely impact the appearance or operation of the faucet or the handle.

The use of a proximity sensor utilizing a reed switch to sense the flow through the faucet of a water heater container by sensing mechanical movement of the faucet handle easily accomplishes sensing of flow from the faucet of a water heater container at reduced cost, reduced weight and improved reliability compared to conventional systems.

It will be apparent from the foregoing that while particular forms of the invention have been illustrated and described, various modifications can be made without departing from the spirit and scope of the invention.

1. A flow sensing apparatus for detecting flow through a faucet of a water heater container, the flow sensing apparatus comprising:
a faucet handle mounted to the faucet of the water heater container, said faucet handle having a movable portion that is movable between an open position allowing flow through the faucet and a closed position preventing flow through the faucet; and
a sensor cooperatively mounted in association with said movable portion of said faucet handle to detect movement of said movable portion of said faucet handle between said open position of the faucet handle and said closed position of the faucet handle, said sensor generating a faucet position signal indicating whether said movable portion of said faucet handle is in said open position of the faucet handle or said closed position of the faucet handle.

2. The flow sensing apparatus of claim 1, wherein said sensor comprises:
a magnet mounted to one of the movable portion of the faucet handle and a fixed location adjacent to the movable portion of the faucet handle; and
a reed switch mounted to the other of the movable portion of the faucet handle and the fixed location adjacent to the faucet handle.

3. The flow sensing apparatus of claim 2, wherein said reed switch is mounted within a portion of the faucet.

4. The flow sensing apparatus of claim 2, wherein said reed switch comprises a normally open, axial, single pole, single throw reed switch.

5. The flow sensing apparatus of claim 1, further comprising:
an electronic control unit configured to receive said faucet position signal to optimize heating of water inside the water heater container responsive to said faucet position signal.

6. The flow sensing apparatus of claim 5, wherein said electronic control unit is configured with a control logic operative to switch on a heating element in the water heater container as soon as the switch faucet position signal is received indicating flow through the faucet.

7. A flow sensing apparatus for detecting flow through a faucet of a water heater container, the flow sensing apparatus comprising:
a faucet handle mounted to the faucet of the water heater container, said faucet handle having a movable portion that is movable between an open position allowing flow through the faucet and a closed position preventing flow through the faucet;
a sensor cooperatively mounted in association with said movable portion of said faucet handle to detect movement of said movable portion of said faucet handle between said open position of the faucet handle and said closed position of the faucet handle, said sensor generating a faucet position signal indicating whether said movable portion of said faucet handle is in said open position of the faucet handle or said closed position of the faucet handle; and
an electronic control unit configured to receive said faucet position signal to optimize heating of water inside the water heater container responsive to said faucet position signal, said electronic control unit being configured with a control logic operative to switch on a heating element in the water heater container as soon as the switch faucet position signal is received indicating flow through the faucet.

8. The flow sensing apparatus of claim 7, wherein said sensor comprises:
a magnet mounted to one of the movable portion of the faucet handle and a fixed location adjacent to the movable portion of the faucet handle; and
a reed switch mounted to the other of the movable portion of the faucet handle and the fixed location adjacent to the faucet handle.

9. The flow sensing apparatus of claim 8, wherein said reed switch comprises a normally open, axial, single pole, single throw reed switch.

10. The flow sensing apparatus of claim 8, wherein said reed switch is mounted within a portion of the faucet.
